(19) United States
(12) Patent Application Publication
(10) Pub. No.: US 2007/0120340 A1
(43) Pub. Date: May 31, 2007

(54) Dual axle motorcycle trailer

(76) Inventor: Benson D. Woods, Federal Way, WA (US)

Correspondence Address: Leggett & Kram, 1901 South I Street, Tacoma, WA, 98405, US

(21) Appl. No.: 11/288,598

(22) Filed: Nov. 28, 2005

(51) Int. Cl. B62K 27/00

(52) U.S. Cl. 280/204

(57) ABSTRACT

A motorcycle trailer having dual axles, electric wheel brakes and a tongue with socket to removably attach to a ball hitch, having wheel axles so arranged upon a base frame so as to distribute the weight of the trailer to maintain stability and avoid fish-tailing when towed, with a design limitation of the under frame being 75″ by 38″ and 27¼″ long which are supported by 4.80/4.00/8 inch wheels and overall height of the trailer not exceeding 19″ above the base frame. The maximum gross weight of the trailer is 580 lbs. with an empty weight of 280 lbs. The remaining configurations may vary.

### CROSS-REFERENCE TO RELATED APPLICATION

NONE

### STATEMENT REGARDING FEDERALLY SPONSORED RESEARCH OR DEVELOPMENT

NONE

### REFERENCE TO A “SEQUENCE LISTING,” A TABLE, OR A COMPUTER PROGRAM LISTING APPENDIX SUBMITTED ON A COMPACT DISC (see 37 CFR 1.52(e)(5))

NONE

### BACKGROUND OF THE INVENTION

(1) Field of the Invention

This invention relates generally to light trailers and more particularly to an improved combination for a motorcycle trailer which enables it to be towed by a motorcycle with a standard ball and socket hitch without experiencing fish-tailing or other instability in the normal operational range of motorcycles on highways.

(2) Description of Related Art including Information Disclosed under 37 CFR 1.97 and 1.98:

It has been long known that it is desirable to be able to pull a trailer with a motorcycle on the highway. Initial efforts involved unicycle arrangements, such as Hawes, U.S. Pat. No. 3,937,489, or single axle arrangements, such as Fox, U.S. Pat. No. 1,613,945. These early efforts attempted to accommodate the lean anticipated by the motorcycle by means of elaborate hitch systems which were both expensive and not readily available. A later disclosure of multiple trailers for a motorcycle, still utilizes a special hitch, Y.C. Liu U.S. Pat. No. 6,312,003. There were some efforts, such as Beckwith, U.S. Design Pat. No. 240,213, which disclosed a single axle trailer with a ball socket hitch means, however, the assembly resulted in instability and fish-tailing of the combination when operated on highways. There was a dual axle pet carrier disclosed in Doyle U.S. Pat. No. 6,766,769, but, again, the anticipated lean of the towing vehicle was accommodated with a special seat post hitch. It has long been known that electronic braking systems can be integrated in motorcycle trailer assemblies, Pettit U.S. Pat. No. 3,909,075, Spechko U.S. Pat. No. 4,222,614, Duvemay U.S. Pat. No. 6,012,780, and Mixon U.S. Pat. No. 6,499,814, but none have integrated an electronic braking system in a dual axle motorcycle trailer utilizing a ball and socket hitch assembly.

Prior art either required a specially designed hitch system or did not eliminate the instability and fish-tailing experienced at highway speeds. This posed a significant risk to operators and the public in general.

### BRIEF SUMMARY OF THE INVENTION

Accordingly, it is an object of this invention to provide an improved combination for a motorcycle trailer which allows it to be towed by standard ball and socket hitch means yet be free from instability and fish-tailing at highway speeds. A further object of this invention is to provide a means to accomplish the first two objectives which is inexpensive to manufacture and simple and durable in design and adaptable to various trailer configurations within the limitations necessary to accomplish the first two objectives. These objects are satisfied by the subject invention comprised of a dual axle low center of gravity trailer, having an overall length of 102.25 inches, to include a 27.25 inch long tongue and trailer under frame length 75 inches and outside width 39.25 inches, being supported by dual axles and 8 inch wheels and the trailer being no more than 19 inches high and the gross weight of the trailer being limited to 580 pounds and empty weight of 280 pounds, which, when mated to a ball hitch assembly with break away safety chains, is readily pulled at high way speeds and off-road by a motorcycle and easily accommodates up to 7 degrees of lean of the motorcycle hitch ball, which is the maximum to be expected in normal highway operation.

The invention, both as to its composition and method of operation, together with further objectives and advantages thereof, may best be understood by reference to the following description taken in connection with the accompanying drawings.

### BRIEF DESCRIPTION OF THE SEVERAL VIEWS OF THE DRAWINGS

FIG. 1 is an elevational view from above of the frame of the trailer.

FIG. 2 is an elevational view of the left side of the trailer.

FIG. 3 is a broken out sectional view of the inside of one of the dual axles with brake, hub and wheel assemblies of the trailer.

FIG. 4 is a bottom elevation view of the trailer.

FIG. 5 is a rear elevational view of the trailer.

FIG. 6 is a front elevational view of the trailer.

FIG. 7 is a rear elevational view of the ball hitch with lean super-imposed.

FIG. 8 is a sectional view of attachment of one end of one of the dual axles.

FIG. 9 is a view of FIG. 8 from 90 degrees of rotation showing the attachment of one end of one of the dual axles.

### DETAILED DESCRIPTION OF THE INVENTION

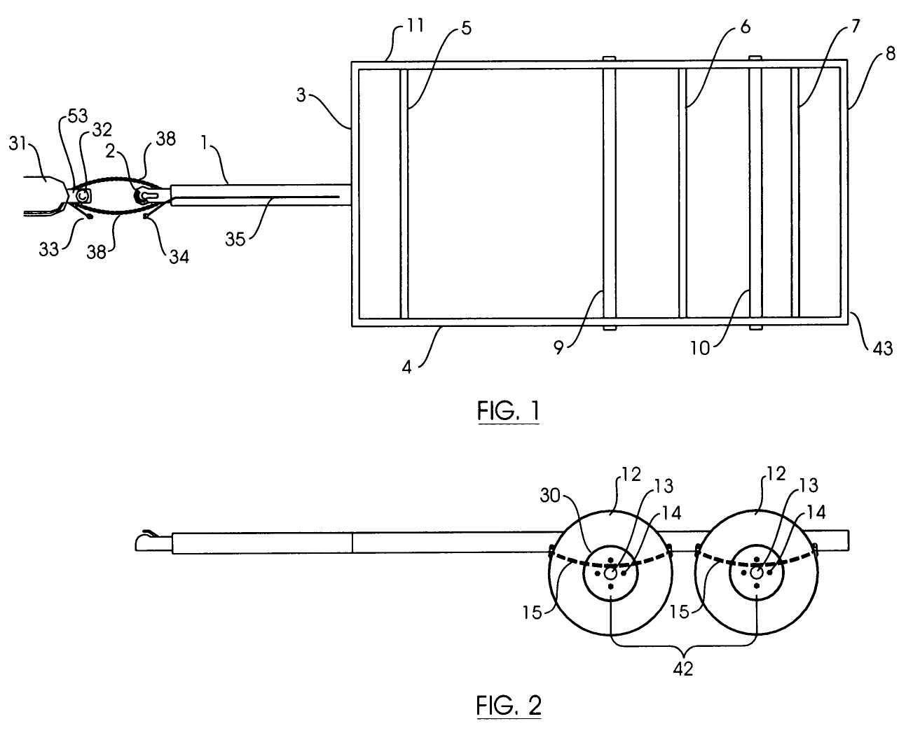

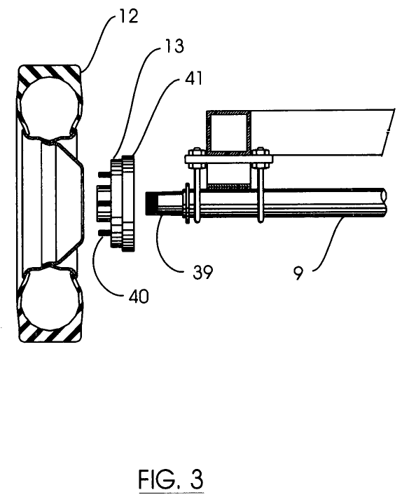

FIG. 1 shows the dual axle motorcycle trailer frame (43), comprised of a front base rail (3), a left side base rail (4), a front cross rail (5), an axle cross rail (6), a rear cross rail (7), a back base rail (8) and a right side base rail (11), being 75 inches in length and 39.25 inches in outside width and having a tongue (1) 27.25 inches long extending from the center of the front base rail (3) and having a hitch ball socket (2) at its end to removable accommodate a 1⅞ inch diameter steel hitch ball (32) mounted at the rear of the motorcycle (31), said tongue (1) having wiring to electric brakes (35) running along its length and ending in an input cannon plug (34) which removable attaches to an outlet cannon plug (33) mounted at the rear of the motorcycle (31) and break away safety chains (38) mounted adjacent to and on either side of the ball socket (2) for removable attachment to a ball hitch anchor plate (53) at the rear of the motorcycle and the whole trailer frame resting on a front axle (9) and rear axle (10).

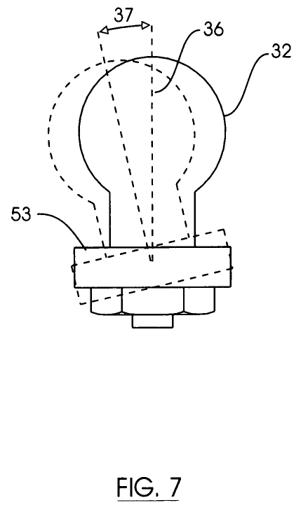

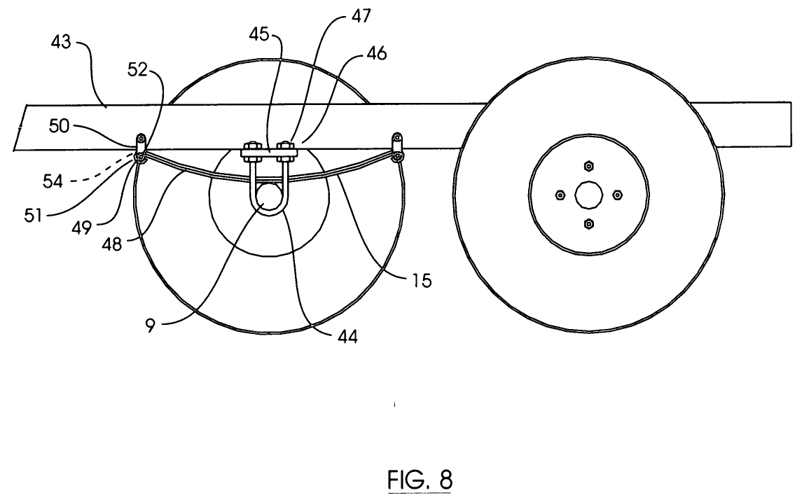

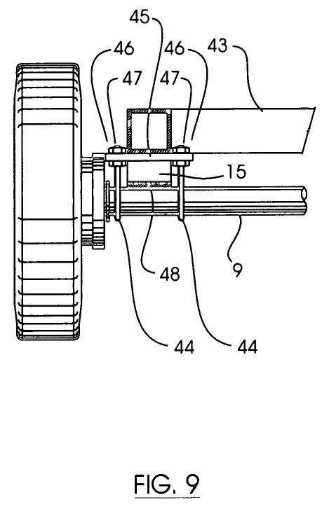

FIG. 7 demonstrates the operational range of lean of the rear of the motorcycle (31) and the hitch ball (32), 7 degrees lean angle (37) of the vertical axis (36) of the hitch ball (32), which can be accommodated by the invention without fish-tailing, disconnection of the hitch or loss of control of the dual axle motorcycle trailer.

With specific reference to FIG. 2, 3, 8 and 9, the detail of the fabrication and installation of the front axle (9) and rear axle (10) to the trailer frame (43) is disclosed. The axles are comprised of 40.5 inch long tubular steel having an 1⅞ inch outside diameter and 1⅝ inch inside diameter to which are welded at each end a threaded spindle (39) upon which is pressed a hub assembly (13) comprised of a hub, such as a Dexter 600 hub p/n 008-173-15 with ½ inch threaded studs (40), an electric controlled brake assemble (41), such as a Dexter 600 LH/RH 7×1¼ electric p/n K23-047-00/k23-048-00, onto which is mounted by removable lug nuts (14) an 4.80/4.00/8 inch wheel (30) and tire (12) and the center of the front axle (9) is located along the along the length of the left and right side base rails (4), (11) 67.25 inches from the end of the tongue (1) and socket (2) and 36 inches from the back base rail (8), and the center of the rear axle (10) is located 22 inches (42) behind the center of the front axle (9), or 89.25 inches from the end of the tongue (1) and socket (2) and 14 inches from the back base rail (8), and rotatably attached to the trailer frame (43) by two U bolts (44) with U bolt attachment assembly (46) comprised of U bolt bracket (45) welded to the underside of the trailer frame (43) through which the threaded end of the U bolt extends and is secured by a U bolt attachment nut (47), one U bolt located on either side of a dual leaf spring (15), having each end rolled to form a tubular female end (51), comprised of two leafs (48) attached by a leaf spring attachment bolt (49) threaded through a leaf spring attachment bracket (50) welded to the trailer frame (43) and having two sides (54) extending perpendicular from the bottom of the trailer frame to accommodate between them the female end (51) of the leaf spring and side leaf spring attachment bolt (49) being secured by a leaf spring attachment nut (52), with each end of the dual axles being similarly attached to the trailer frame (43).

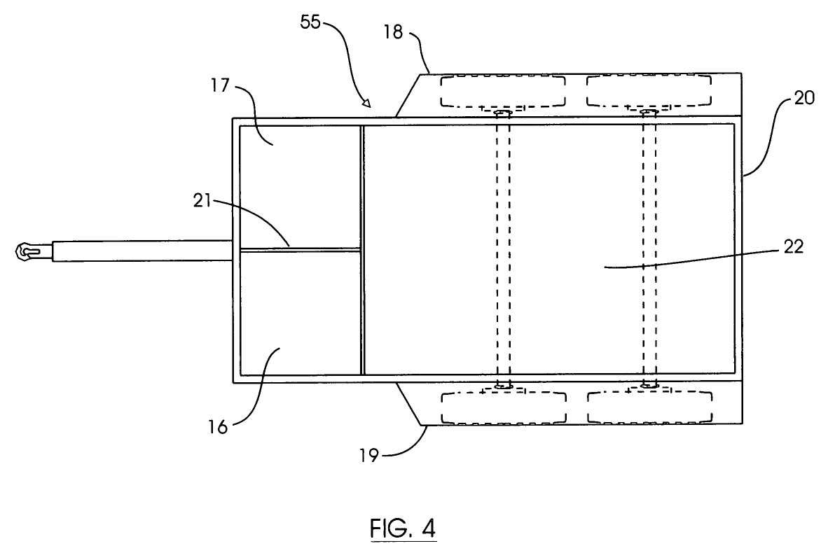

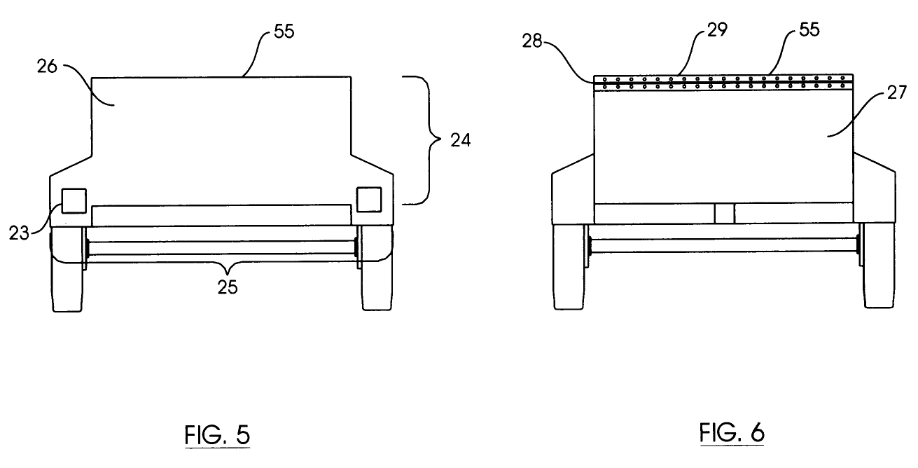

FIG. 4, 5, and 6 illustrate a configuration of the cargo enclosure (55) of the trailer above the trailer frame (43) comprised of front face (27) rising from the front base rail (3) and forming the front side of a front left compartment (16) and a front right compartment (17) having a front compartment divider (21) which acts as a stiffener, a main compartment (22) extending from the two front compartments to the back end (20) and having a flare right side (18) and a flare left side (19) of sheet metal aerodynamically shaped to encase the wheels (30) ending in a flat rear face (26) having brake lights (23) located in the terminus of the flared left and right side (19), (18) and the inside dimension (25) of the flare side being 37.0 inches and the outside dimension being 52.0 inches. The height (24) of the trailer above the base rails is 19 inches and the trailer is equipped with a top (29) rotatably secured to the front face (27) by a piano hinge (28).

The foregoing disclosure and description of the invention are illustrative and explanatory thereof and, it will be understood by those skilled in the art, that various changes in the size, shape and materials, as well as in the details of the illustrated construction, may be made within the scope of the appended claims without departing from the scope or spirit of the invention, so long as the proportions and limitations on length, width, height and gross weight are maintained.

I claim:

1. An improved motorcycle trailer being comprised of a dual axle motorcycle trailer frame means, a hitch means for removably attaching the trailer to a motorcycle, an electronic brake means for remotely controlling electronic brakes and brake lights on the trailer, a dual axle means and a cargo enclosure means, so that the maximum gross weight of the trailer is 580 lbs. with an empty weight of 280 lbs.

2. The dual axle motorcycle trailer frame means of claim 1 comprised of a front base rail, a left side base rail, a front cross rail, an axle cross rail, a rear cross rail, a back base rail and a right side base rail, being 75 inches in length and 39.25 inches in outside width and having a tongue 27.25 inches long extending from the center of the front base rail.

3. The hitch and electronic brake means of claim 1 being comprised of a hitch ball socket at the end of the tongue opposite to the front base rail to removable accommodate a 1⅞ inch diameter steel hitch ball mounted at the rear of the motorcycle on a ball hitch anchor plate, said tongue having wiring to electric brakes running along its length and ending in an input cannon plug which removable attaches to an outlet cannon plug mounted at the rear of the motorcycle and a set of break away safety chains mounted adjacent to and on either side of the ball socket for removable attachment to the ball hitch anchor plate at the rear of the motorcycle and the whole trailer frame resting on a front axle and a rear axle so as to enable an operational range of lean of the rear of the motorcycle and the hitch ball, 7 degrees lean angle of the vertical axis of the hitch ball, without fish-tailing, disconnection of the hitch means or loss of control of the dual axle motorcycle trailer.

4. The dual axle means of claim 1 being comprised a front axle and rear axle comprised of 40.5 inch long tubular steel having an 1⅞ inch outside diameter and 1⅝ inch inside diameter to which are welded at each end a threaded spindle upon which is pressed a hub assembly, comprised of a hub and an electric controlled brake assemble onto which is mounted by removable lug nuts an 4.80/4.00/8 inch wheel and tire and the center of the front axle is located along the along the length of the left and right side base rails 67.25 inches from the end of the tongue and socket and 36 inches from the back base rail, and the center of the rear axle is located 22 inches behind the center of the front axle, or 89.25 inches from the end of the tongue and socket, and 14 inches from the back base rail and rotatably attached to the trailer frame by two U bolts (44) with a U bolt attachment assembly comprised of a U bolt bracket welded to the underside of the trailer frame through which the threaded end of the a U bolt extends and is secured by a U bolt attachment nut, one U bolt located on either side of a dual leaf spring, having each end rolled to form a tubular female end, comprised of two leafs attached by a leaf spring attachment bolt threaded through a leaf spring attachment bracket welded to the trailer frame and having two sides extending perpendicular from the bottom of the trailer frame to accommodate between them the female end of the leaf spring and side leaf spring attachment bolt being secured by a leaf spring attachment nut, with each end of the dual axles being similarly attached to the trailer frame.

5. The cargo enclosure means of claim 1 comprised of front face rising from the front base rail and forming the front side of a front left compartment and a front right compartment, having a front compartment divider which acts as a stiffener, a main compartment extending from the two front compartments to the rear face extending up from the back base rail, and having a flare right side and a flare left side of sheet metal aerodynamically shaped to encase the wheels ending in a flat rear face having brake lights located in the terminus of the flared left and right side and the inside dimension of the flare side being 37.0 inches and the outside dimension being 52.0 inches and the height of the cargo enclosure above the base rails is 19 inches and the trailer is equipped with a top rotatably secured to the front face by a piano hinge.
